(19) United States
(12) Patent Application Publication
(10) Pub. No.: US 2017/0168079 A1
(43) Pub. Date: Jun. 15, 2017

(54) SET OF SAMPLE CONTAINER CARRIERS FOR A LABORATORY SAMPLE DISTRIBUTION SYSTEM, LABORATORY SAMPLE DISTRIBUTION SYSTEM AND LABORATORY AUTOMATION SYSTEM

(71) Applicant: Roche Diagnostics Operations, Inc., Indianapolis, IN (US)

(72) Inventor: Achim Sinz, Waiblingen (DE)

(21) Appl. No.: 15/444,744

(22) Filed: Feb. 28, 2017

Related U.S. Application Data
(63) Continuation of application No. PCT/EP2015/070453, filed on Sep. 8, 2015.

(30) Foreign Application Priority Data
Sep. 9, 2014 (EP) 14184044.7

(51) Int. Cl. G01N 35/04; B65G 54/02; B01L 9/06

(52) U.S. Cl. CPC G01N 35/04; B01L 9/06; B65G 54/02; G01N 2035/0406; G01N 2035/0477

(57) ABSTRACT

A set of sample container carriers, a laboratory sample distribution system comprising such a set of sample container carriers, and a laboratory automation system comprising such a laboratory sample distribution system are presented. The set of sample container carriers comprises sample container carriers of a first type and a second type. Magnetic fields generated by respective magnetically active devices of the sample container carriers having the first type are oriented opposite to magnetic fields of respective magnetically active devices of the sample container carriers having the second type.

### CROSS-REFERENCE TO RELATED APPLICATIONS

This application is a continuation of PCT/EP2015/070453, filed Sep. 8, 2015, which is based on and claims priority to EP 14184044.7, filed Sep. 9, 2014, which is hereby incorporated by reference.

### BACKGROUND

The present disclosure relates to a set of sample container carriers for a laboratory sample distribution system, a laboratory sample distribution system comprising such a set of sample container carriers and to a laboratory automation system comprising such a laboratory sample distribution system.

Laboratory automation systems typically comprise a number of analytical stations, for example pre-analytical, analytical and/or post-analytical stations. Such stations can be used in order to analyze samples such as blood samples or other medical samples and in order to perform corresponding tasks like decapping or centrifugation. A laboratory sample distribution system can be used in order to automatically distribute or transport sample containers between such laboratory stations, wherein a sample container typically comprises a sample. The sample containers are typically made of transparent plastic material or glass material and are typically embodied as a tube having an opening at the top side.

A typical laboratory sample distribution system comprises a number of sample container carriers and a transport plane having a number of electro-magnetic actuators positioned below the transport plane, such that the electro-magnetic actuators can move the sample container carriers over the transport plane. Such laboratory sample distribution systems provide for a high throughput in laboratory automation systems.

However, there is a need to provide for set of sample container carriers, a laboratory sample distribution system and a laboratory automation system that further increase sample throughput.

### SUMMARY

According to the present disclosure, a set of sample container carriers for a laboratory sample distribution system is presented. The set of sample container carriers can comprise sample container carriers having a first sample container carrier type and a second sample container carrier type. The sample container carries can be adapted to carry one or more sample and can comprise at least one magnetically active device. A magnetic field generated by the magnetically active device of each of the sample container carriers having the first sample container carrier type can be oriented opposite to a magnetic field generated by the magnetically active device of each of the sample container carriers having the second sample container carrier type.

In accordance with one embodiment of the present disclosure, a laboratory sample distribution system is presented. The laboratory sample distribution system can comprise a set of sample container carriers as described above, a transport surface adapted to support the sample container carriers comprised in the set of sample container carriers, and a number of electro-magnetic actuators stationary arranged below the transport surface. The electro-magnetic actuators can be adapted to move the sample container carriers comprised in the set of sample container carriers on top of the transport surface by applying a magnetic force to the sample container carriers comprised in the set of sample container carriers. The laboratory sample distribution system can also comprise a control unit configured to control the movement of the sample container carriers comprised in the set of sample container carriers on top of the transport surface by driving the electro-magnetic actuators such that the sample container carriers comprised in the set of sample container carriers move along corresponding transport paths.

Accordingly, it is a feature of the embodiments of the present disclosure to provide for set of sample container carriers, a laboratory sample distribution system and a laboratory automation system that increase sample throughput. Other features of the embodiments of the present disclosure will be apparent in light of the description of the disclosure embodied herein.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates a laboratory automation system comprising a laboratory sample distribution system according to an embodiment of the present disclosure.

FIG. 2 illustrates a part of the laboratory sample distribution system in a sectional view according to an embodiment of the present disclosure.

### DETAILED DESCRIPTION

In the following detailed description of the embodiments, reference is made to the accompanying drawings that form a part hereof, and in which are shown by way of illustration, and not by way of limitation, specific embodiments in which the disclosure may be practiced. It is to be understood that other embodiments may be utilized and that logical, mechanical and electrical changes may be made without departing from the spirit and scope of the present disclosure.

A set (group, compilation, composition) of sample container carriers for a laboratory sample distribution system is presented. The set of sample container carriers can comprise a number (about 2 to about 200) of sample container carriers having a first sample container carrier type and a number (about 2 to about 200) of sample container carriers having a second sample container carrier type different from the first sample container carrier type. Typically, the sample container carriers having the first sample container carrier type can differ from the sample container carriers having the second sample container carrier type by at least one property.

One or more sample container carriers of the set of sample container carriers can be adapted to carry one or more sample containers. According to one embodiment, all sample container carriers of the set of sample container carriers can be adapted to carry one or more sample containers. The ability to carry sample containers can be independent of the sample container carrier type.

Each sample container carrier can comprise at least one magnetically active device that can typically be used to interact with a magnetic field generated by the electro-magnetic actuators such that a drive force can act on the sample container carrier.

A respective magnetic field generated by the magnetically active device of each of the sample container carriers having the first sample container carrier type can be oriented opposite to a respective magnetic field generated by the magnetically active device of each of the sample container carriers having the second sample container carrier type, i.e., the at least one property different between the first and second type can be the orientation of the respective magnetic field.

By use of the set of sample container carriers, it can be possible to simultaneously move sample container carriers positioned along a line having a distance corresponding to a distance between centers of the electro-magnetic actuators. This functionality may typically not be possible when all sample container carriers moving on a transport plane have the same orientation of the respective magnetic fields generated by the respective magnetically active devices, as the attraction force of one electro-magnetic actuator can pull both sample container carriers to its center, what is their opposite direction and not to the same direction where they should move simultaneously.

It can be understood that the orientation of a magnetic field can typically be given by vectors defining the magnetic field. A magnetic field can be defined by a plurality of vectors having a certain orientation and a certain amount or value, wherein the amount can correspond to the respective field strength. Such a plurality of vectors can also be called a vector field. When a magnetic field of a first magnet is oriented opposite to a magnetic field of a second magnet, this can, for example, mean that vectors of a vector field defining the magnetic field of the first magnet can be reversed to vectors of a vector field defining the magnetic field of the second magnet.

It can be understood that according to a typical embodiment, the magnetic fields generated by the magnetically active devices of the sample container carriers having the first sample container carrier type can differ from the magnetic fields generated by the magnetically active devices of the sample container carriers having the second sample container carrier type by about 180°.

According to one embodiment, the sample container carriers can each comprise a permanent (bar) magnet as its respective magnetically active device. In such a case, generation of an opposite magnetic field can, for example, be accomplished by rotating the permanent (bar) magnet about a horizontal axis by about 180°.

According to one embodiment, the permanent magnet can be adapted to be rotated with respect to the rest of the sample container carrier by about 180°. This can, for example, be accomplished by providing a possibility to rotate the magnet inside the sample container carrier, or to provide for a possibility to take out the magnet out of the sample container carrier, to rotate the magnet, and to insert the magnet into the sample container carrier. This can allow for an adaptation of the orientation of a magnetic field generated by a magnetically active device of a sample container carrier according to actual needs in order to increase system throughput. For example, if a line of sample container carriers should be arranged in which each pair of neighboring sample container carriers has opposite magnetic fields of its respective magnetically active devices, some magnets can be rotated in order to provide for an equal number of sample container carriers having each of the two orientations of the magnetic fields. The system may have a sufficient number of sample container carriers having corresponding orientations of the permanent magnets. Each sample container carrier may comprise identification (e.g., RFID) such that the system can know the orientation of the permanent magnet within the sample container carrier in order to control/trigger the electro-magnetic actuator with the correct magnetic field.

According to one embodiment, each magnetic field generated by a magnetically active device can correspond to a magnetic field generated by a coil having a vertical axis. It can also correspond to a magnetic field generated by a bar magnet. Such magnetic fields can typically be represented as vector fields, such that an orientation can be determined. The fields may leave a coil or a bar magnet approximately vertically. Typically vectors of the magnetic field having a larger distance from the magnetically active device above or below the coil or bar magnet can be more inclined compared with vectors closer to the magnetically active device.

According to one embodiment, the sample container carriers can each comprise an electro-magnet as its magnetically active device. With such an electro-magnet, both the orientation and the strength of the magnetic field can be adjusted even during operation. According to an embodiment, each sample container carrier can comprise a method for switching an orientation of a magnetic field generated by the electro-magnet by about 180°. Such a method may, for example, be adapted as a switch for inverting current flow through a coil comprised by the electro-magnet.

According to an embodiment, one or more sample container carriers having the first sample container carrier type and one or more sample container carrier having the second sample container carrier type can be concatenated to form a single composite sample container carrier. The concatenation may be realized by detachable couplings between the sample container carriers. This can allow using magnetically active devices of both orientations, for example, two magnetically active devices of opposite orientations, in a single composite sample container carrier. The magnetically active devices of such composite sample container carriers can be treated by a control unit similarly to treating two adjacent independent sample container carriers. A composite sample container carrier concatenated as described may comprise one or more holders for sample containers. For example, it may be embodied as a rack for holding a plurality of sample containers.

A laboratory sample distribution system is also presented. The laboratory sample distribution system can comprise a set of sample container carriers described above. The laboratory sample distribution system can further comprise a transport surface adapted to support the sample container carriers. Below the transport surface, a number of electro-magnetic actuators can be arranged. The electro-magnetic actuators can be adapted to move the sample container carriers on top of the transport surface by applying a magnetic force to the sample container carriers. The laboratory sample distribution system can further comprise a control unit configured to control the movement of the sample container carriers on top of the transport surface by driving the electro-magnetic actuators such that the sample container carriers can move along corresponding transport paths.

The control unit can be implemented, for example, as a microcontroller, a microprocessor, an Application Specific Integrated Circuit (ASIC) or another programmable device. Especially the control unit may comprise a processor and memory. Code can be stored in the memory controlling the behavior of the processor.

By an inventive laboratory sample distribution system, throughput can be increased because it can be possible to simultaneously move sample container carriers arranged along a line with a distance corresponding to a distance between centers of adjacent electro-magnetic actuators. This can, for example, be accomplished by embodiments as discussed further below.

According to one embodiment, the control unit can be configured to drive the electro-magnetic actuators such that in at least one line of adjacent electro-magnetic actuators magnetic fields generated by each pair of directly adjacent electro-magnetic actuators can be oriented opposite to each other. Regarding definitions of orientation, reference is made to the statements regarding orientation of magnetic fields given above with respect to magnetic fields generated by magnetically active devices of the sample container carriers.

Having magnetic fields of adjacent electro-magnetic actuators oriented opposite to each other can allow for simultaneous movement of a plurality of sample container carriers having alternating types and arranged in a line. Thus, each sample container carrier can be attracted by one electro-magnetic actuator and can be repulsed by another electro-magnetic actuator. Such a simultaneous movement may not be possible if the magnetic fields of the magnetically active devices of all sample container carriers have the same orientation, because in such a case, an attractive magnetic force exerted on a certain sample container carrier can inadvertently lead to an attractive magnetic force on another sample container carrier pointing in an undesired direction.

According to one embodiment, the control unit can be configured to drive the electro-magnetic actuators such that a number of sample container carriers arranged along a line of electro-magnetic actuators and having a distance corresponding to a distance between the electro-magnetic actuators can move simultaneously. This is an operation that can be possible when a set of sample container carriers is used. It can allow for a high throughput because a plurality of sample container carriers can move simultaneously with a minimum distance between the sample container carriers. Further, by one electro-magnetic field, a force on two sample container carriers moving to the same direction may be caused. Therefore the entire system will need less power to move the same amount of sample container carriers.

A distance between electro-magnetic actuators may be understood as a distance between respective centers of electro-magnetic actuators.

According to one embodiment, the control unit can be configured to drive the electro-magnetic actuators such that a number of sample container carriers arranged in a field can move simultaneously. Adjacent sample container carriers arranged in the field can have a distance corresponding to a distance between the electro-magnetic actuators in one or two directions. This can allow for simultaneous movement of a two-dimensional field of sample container carriers.

According to one embodiment, the control unit can be configured to receive or determine the type of a sample container carrier and to adjust its driving of the electro-magnetic actuators in response to the determined type. For example, an orientation of the magnetic field generated by an electro-magnetic actuator may be generated in a first direction for the first type and may be generated in a second direction, opposite to the first direction for the second type. The type can, for example, be received from an RFID tag, or another wireless communications, installed in the sample container carrier. It can also be determined, for example, by Hall-sensors or other magnetic sensors. Knowledge about the respective type can allow for an efficient handling of the sample container carriers by the control unit with a high throughput.

According to an embodiment, the control unit can be configured to move a number of sample container carriers such that the sample container carriers can be aligned along a line of electro-magnetic actuators. A distance between adjacent sample container carriers can correspond to a distance between the electro-magnetic actuators. Magnetic fields generated by each pair of magnetically active devices of directly adjacent sample container carriers can be oriented opposite to each other. The control unit can be, according to this embodiment, configured to move the sample container carriers simultaneously along a common path or line.

This embodiment can allow for an effective routing of a plurality of sample container carriers that travel a similar path. For example, similar paths can be understood as paths originating in a certain region on the transport surface and ending in another, distant region on the transport surface. By this embodiment, it can be possible to align sample container carriers having similar paths such that they can move simultaneously and thus can require a minimum space on the transport surface and a minimum of time in order to come to their destination.

According to one embodiment, the laboratory sample distribution system can comprise a loading station adapted to perform one or more of the following tasks: loading of sample containers on sample container carriers, unloading of sample containers from sample container carriers, filling samples in sample containers, and/or extracting samples from sample containers.

The loading station can be adapted for parallel operation with a plurality of sample containers each assigned to a sample container carrier. The sample container carriers can be aligned along a line of electro-magnetic actuators such that a distance between adjacent sample container carriers can correspond to a distance between the electro-magnetic actuators.

By this embodiment, it can be possible to load, or unload, samples or sample containers in parallel on or from a plurality of sample container carriers. Typically, a region corresponding to the loading station can be defined on the transport surface. A plurality of sample container carriers can be positioned in that region that can be operated by the loading station in parallel. The sample container carriers can be moved simultaneously in that region, especially if two adjacent sample container carriers have opposite magnetic fields.

According to an embodiment, the laboratory sample distribution system can comprise inverting a magnetic field of magnetically active elements such as, for example, by taking out a permanent magnet from a sample container carrier and/or rotating and re-inserting the permanent magnet. This can allow for controlling respective orientations of electro-magnetic fields such that the sample container carriers can be operated as effectively as possible.

A laboratory automation system is presented. The laboratory automation system can comprise a number of a pre-analytical, analytical and/or post-analytical (laboratory) stations, and a laboratory sample distribution system as described above adapted to transport the sample container carriers and/or sample containers between the stations. The stations may be arranged adjacent to the laboratory sample distribution system.

Pre-analytical stations may be adapted to perform any kind of pre-processing of samples, sample containers and/or sample container carriers.

Analytical stations may be adapted to use a sample or part of the sample and a reagent to generate a measuring signal, the measuring signal indicating if and in which concentration, if any, an analyte exists.

Post-analytical stations may be adapted to perform any kind of post-processing of samples, sample containers and/or sample container carriers.

The pre-analytical, analytical and/or post-analytical stations may comprise at least one of a decapping station, a recapping station, an aliquot station, a centrifugation station, an archiving station, a pipetting station, a sorting station, a tube type identification station, a sample quality determining station, an add-on buffer station, a liquid level detection station, and a sealing/desealing station.

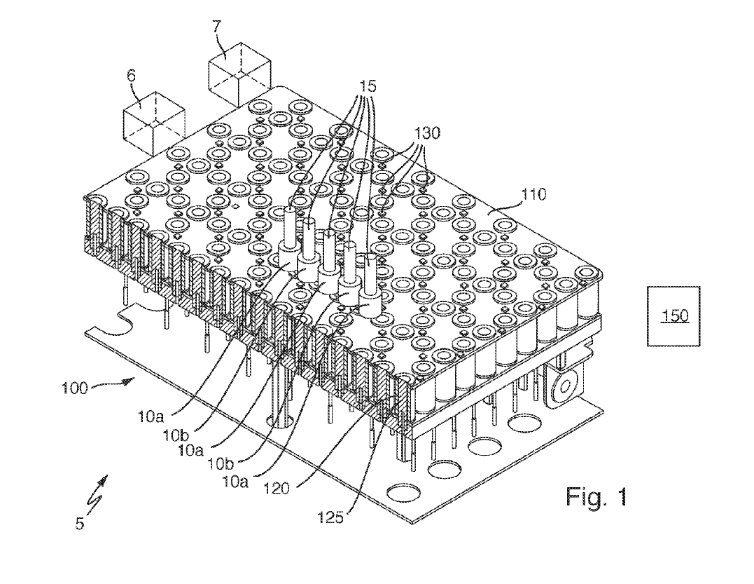

Referring initially to FIG. 1, FIG. 1 shows a laboratory automation system 5 comprising a first laboratory station 6, a second laboratory station 7 and a laboratory sample distribution system 100. The laboratory stations 6, 7 can be adapted to perform certain analytical, pre-analytical and/or post-analytical tasks.

The laboratory sample distribution system 100 can be adapted to move sample container carriers 10a, 10b between the laboratory stations 6, 7 and other equipment not shown in FIG. 1. It can be noted that typically a laboratory sample distribution system 100 can operate in connection with more than two laboratory stations 6, 7.

The laboratory sample distribution system 100 can comprise a transport surface 110, on which sample container carriers 10a, 10b can move. Three sample container carriers 10a and two sample container carriers 10b are shown exemplarily.

Under the transport surface 110, a plurality of electro-magnetic actuators 120 can be arranged. Each electro-magnetic actuator 120 can comprise a ferromagnetic core 125. The electro-magnetic actuators 120 can be aligned in a vertical orientation.

In order to determine respective positions of the sample container carriers 10a, 10b, a plurality of Hall-sensors 130 can be distributed over the transport surface 110.

The laboratory sample distribution system 100 can comprise a control unit 150, which can be adapted to control the electro-magnetic actuators 120 such that the sample container carriers 10a, 10b can move on respective transport paths. For this task, the control unit 150 can receive and use information from the Hall-sensors 130 in order to determine the positions of the sample container carriers 10a, 10b.

Each sample container carrier 10a, 10b can hold a respective sample container 15. Each sample container 15 can be filled with a respective medical sample that can be analyzed using the laboratory stations 6, 7.

The control unit 150 can be configured to simultaneously move the sample container carriers 10a, 10b shown in FIG. 1 arranged in a line with a distance between the sample containers 10a, 10b corresponding to respective distances between the electro-magnetic actuators 120.

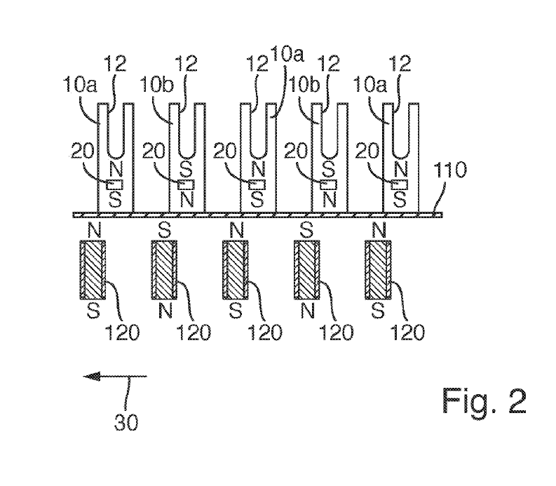

FIG. 2 shows a partial sectional view of the laboratory sample distribution system 100 shown in FIG. 1. The sample container carriers 10a, 10b can be arranged along a line. As depicted, each sample container carrier 10a, 10b can comprise a sample container holder 12 adapted to hold a respective sample container. However, the sample containers are not shown in FIG. 2.

The sample containers 10 can be arranged on the transport surface 110. Below the transport surface 110, five of the electro-magnetic actuators 120 are shown schematically. Each of the sample container carriers 10a, 10b can comprise a respective magnetically active device in the form of a permanent bar magnet 20. The respective permanent magnet 20 of the sample container carriers 10a can be oriented such that the north pole can face away from the transport plane 110. The respective permanent magnet 20 of the sample container carriers 10b can be oriented such that the north pole can face towards transport plane 110. In each case, an axis connecting north pole and south pole of the respective permanent magnet 20 can be aligned in a vertical direction.

The sample container carriers 10a, 10b form a set of sample container carriers 10a, 10b. The set of sample container carriers can comprise three sample container carriers 10a having a first type and two sample container carriers 10b having a second type. The sample container carriers 10a having the first type can comprise a permanent magnet 20 having a north pole at the upper side and the sample container carriers 10b having the second type can comprise a permanent magnet 20 having a north pole at the lower side.

As depicted in FIG. 2, the permanent magnets 20 of the sample container carriers 10a, 10b can be arranged such that two permanent magnets 20 of adjacent sample container carriers 10a, 10b can generate opposite magnetic fields. In other words, permanent magnets 20 having north pole and south pole at the upper side can alternate along the extension of the line in which the sample container carriers 10a, 10b can be arranged.

In order to drive the sample container carriers 10 along a direction of movement that is shown by an arrow 30 in FIG. 2, the electro-magnetic actuators 120 can be energized by the control unit 150 such that north poles and south poles at the upper side and at the lower side can alternate along the line in which the electro-magnetic actuators 120 can be arranged.

Regarding, for example, the sample container carrier 10a and the electro-magnetic actuator 120 that are arranged at the left side of FIG. 2, it can be seen that a north pole of the electro-magnetic actuator 120 faces a south pole of the permanent magnet 20 of the sample container carrier 10a. Consequently, the sample container carrier 10a can be attracted to the left. Regarding other pairs of sample container carriers 10a, 10b and electro-magnetic actuators 120, the same can apply with alternating poles. Consequently, the whole line of sample container carriers 10 can be attracted to the left simultaneously.

Thus, the control unit 150 can energize the electro-magnetic actuators 120 sample container carrier type dependent such that sample container carriers 10a, 10b arranged in a line can move simultaneously without a need for gaps between the sample container carriers 10a, 10b. This can allow for a high throughput of the laboratory sample distribution system 100. In order to implement this functionality, the control unit 150 can be configured to maintain a database about the sample container carriers 10 of the laboratory sample distribution system 100. The database can contain information about respective orientations of the permanent magnets 20 of the sample container carriers 10a, 10b, i.e. the respective types of the sample container carriers 10a, 10b.

It is noted that terms like “preferably,” “commonly,” and “typically” are not utilized herein to limit the scope of the claimed embodiments or to imply that certain features are critical, essential, or even important to the structure or function of the claimed embodiments. Rather, these terms are merely intended to highlight alternative or additional features that may or may not be utilized in a particular embodiment of the present disclosure.

Having described the present disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure.

We claim:

1. A set of sample container carriers for a laboratory sample distribution system, the set of sample container carriers comprising:
sample container carriers having a first sample container carrier type and a second sample container carrier type, the sample container carries are adapted to carry one or more sample and comprise at least one magnetically active device, wherein a magnetic field generated by the magnetically active device of each of the sample container carriers having the first sample container carrier type is oriented opposite to a magnetic field generated by the magnetically active device of each of the sample container carriers having the second sample container carrier type.

2. The set of sample container carriers according to claim 1, wherein the magnetically active device is a permanent magnet.

3. The set of sample container carriers according to claim 1, wherein a sample container carrier having the first sample container carrier type and a sample container carrier having the second sample container carrier type are concatenated to form a composite sample container carrier.

4. A laboratory sample distribution system, the laboratory sample distribution system comprising:
a set of sample container carriers according to claim 1;
a transport surface adapted to support the sample container carriers comprised in the set of sample container carriers;
a number of electro-magnetic actuators stationary arranged below the transport surface, the electro-magnetic actuators adapted to move the sample container carriers comprised in the set of sample container carriers on top of the transport surface by applying a magnetic force to the sample container carriers comprised in the set of sample container carriers; and
a control unit configured to control the movement of the sample container carriers comprised in the set of sample container carriers on top of the transport surface by driving the electro-magnetic actuators such that the sample container carriers comprised in the set of sample container carriers move along corresponding transport paths.

5. The laboratory sample distribution system according to claim 4, wherein the control unit is configured to drive the electro-magnetic actuators such that in at least one line of adjacent electro-magnetic actuators magnetic fields generated by each pair of directly adjacent electro-magnetic actuators are oriented opposite to each other.

6. The laboratory sample distribution system according to claim 4, wherein the control unit is configured to drive the electro-magnetic actuators such that a number of sample container carriers arranged along a line of electro-magnetic actuators and having a distance corresponding to a distance between the electro-magnetic actuators move simultaneously.

7. The laboratory sample distribution system according to claim 4, wherein the control unit is configured to drive the electro-magnetic actuators sample container carrier type dependent.

8. The laboratory sample distribution system according to claim 4, wherein the control unit is configured to move a number of sample container carriers such that the sample container carriers are aligned along a line of electro-magnetic actuators such that a distance between adjacent sample container carriers corresponds to a distance between the electro-magnetic actuators such that magnetic fields generated by each pair of magnetically active devices of directly adjacent sample container carriers are oriented opposite to each other and such that the sample container carriers move simultaneously along a common path.

9. The laboratory sample distribution system according to claim 4, further comprises, a loading station adapted to perform one or more of the following tasks:
loading of sample containers on sample container carriers,
unloading sample containers from sample container carriers,
filling samples in sample containers, and
extracting samples from sample containers,
wherein the loading station is adapted for parallel operation with a plurality of sample containers each being assigned to a sample container carrier, the sample container carriers aligned along a line of electro-magnetic actuators such that a distance between adjacent sample container carriers corresponds to a distance between the electro-magnetic actuators.

10. A laboratory automation system, the laboratory automation system comprising:
a number of laboratory stations; and
a laboratory sample distribution system according to claim 4 adapted to distribute the sample container carriers between the stations.

11. The laboratory automation system according to claim 10, wherein the laboratory stations are pre-analytical, analytical and/or post-analytical stations
